(19) United States
(12) Patent Application Publication
(10) Pub. No.: US 2014/0332035 A1
(43) Pub. Date: Nov. 13, 2014

(54) METHOD FOR VAPOR-CLEANING OBJECT TO BE CLEANED AND DEVICE THEREFOR

(71) Applicants: Masatoshi Uchino, Tokyo (JP); Masahide Uchino, Tokyo (JP)

(72) Inventors: Masatoshi Uchino, Tokyo (JP); Masahide Uchino, Tokyo (JP)

(73) Assignee: JAPAN FIELD CO., LTD., Tokyo (JP)

(21) Appl. No.: 14/372,169

(22) PCT Filed: Aug. 27, 2012
(86) PCT No.: PCT/JP2012/005349

§ 371 Date: Jul. 14, 2014

(30) Foreign Application Priority Data
Jun. 8, 2012 (JP) 2012-130415

(51) Int. Cl. B08B 3/00

(52) U.S. Cl. CPC B08B 3/00
USPC 134/31; 15/302

(57) ABSTRACT

When an object to be cleaned is vapor cleaned in the prior art, a tubular cleaning tube is arranged on the top face of the cover plate, at the outer periphery of the outlet, so that the cleaning vapor can accumulate, allowing very little pushing out the air in the working chamber. In the present invention, an outlet is provided in a cover plate through which cleaning vapor flows out into an ordinary pressure working chamber thereabove; condensation of this outflowing cleaning vapor at a low position in the ordinary pressure working chamber is made possible by a condensation unit; and a tubular cleaning tube is arranged at the outer periphery of the outlet on the top face of a cover plate, whereby the cleaning vapor rises up in the cleaning tube so that an object to be cleaned can be vapor cleaned by receiving it in this cleaning tube.

### TECHNICAL FIELD

The present invention relates to a method of vapor cleaning an object to be cleaned performed in an ordinary pressure environment and a device for the same, an object thereof being the prevention of dispersion of cleaning solvent into the atmosphere, so as to reduce the environmental impact, and so as to lower the cost of vapor cleaning an object to be cleaned by reducing the amount of cleaning solvent consumed when vapor cleaning the object to be cleaned.

### BACKGROUND ART

Conventionally, a method of vapor cleaning an object to be cleaned in an ordinary pressure environment is known in which a cleaning solvent loaded in an ordinary pressure vapor generator is heated so as to generate cleaning vapor that fills a working chamber thereabove, an object to be cleaned is brought into contact with the cleaning vapor in this working chamber, and vapor cleaning is performed, as set forth in Patent Document 1. In this conventional method, a condensation unit is configured at the top end of the working chamber in which the vapor cleaning is performed, whereby the cleaning vapor that has been generated rises upward in the working chamber as far as the location at which it makes contact with the condensation unit provided at the top end thereof, so as to fully fill the working chamber with cleaning vapor.

### PRIOR ART DOCUMENTS

### Patent Documents

Patent Document 1: JP-06-073580-A

### SUMMARY OF THE INVENTION

### Problems to Be Solved by the Invention

However, because the vapor density of cleaning solvent vapor is generally approximately 3 to 6 times that of air, it is heavier than air, and when the vapor rises, the air that is present at that position is pushed upwards, so that the air in the working chamber provided above the cleaning tank is pushed out to the exterior, where it is dispersed. Consequently, air containing the cleaning solvent is dispersed to the exterior, which not only has a great environmental impact, but increases the consumption of cleaning solvent, which results in increased cleaning costs. Furthermore, when the object to be cleaned is placed in the working chamber that has been filled with cleaning vapor, the cleaning vapor is condensed by the object to be cleaned, which rapidly decreases the vapor level. External air in an amount corresponding to this decrease will flow into the cleaning tank. There were problems in so much as, as a result of repeating this, the environmental impact increased and the consumption of cleaning solvent increased. Furthermore, 1,1,1-trichloroethane and Freon 113, which are ozone depleting substances, have been banned, and because replacement cleaning solvents are more expensive than the cleaning solvents that were conventionally used, the consumption of cleaning solvents constitutes a serious problem. Furthermore, with a view to solving these problems, methods are known in which vapor cleaning is performed within a sealed vacuum tank, but there are disadvantages to this in that the equipment is expensive.

The present invention is directed to solving problems such as those described above, and is directed to allowing for vapor cleaning of an object to be cleaned at low cost, using ordinary pressure vapor cleaning equipment that can be manufactured inexpensively, while lowering the impact on the environment that accompanies outflow of cleaning solvents and reducing cleaning solvent loss. Note that, in the instant specification, the term tube is used as concept including tubes whose section is circular, rectangular, triangular, polygonal or the like.

### Means for Solving the Problems

In order to solve problems such as those described above, the instant invention results from: providing an outlet in a cover plate, through which cleaning vapor flows out into an ordinary pressure working chamber thereabove, allowing for condensation of this outflowing cleaning vapor by a condensation unit at a low position in the ordinary pressure working chamber; and arranging a tubular cleaning tube at the outer periphery of the outlet, on the top face of a cover plate, whereby the cleaning vapor rises up in the cleaning tube, such that an object to be cleaned can be vapor cleaned by receiving the object to be cleaned in this cleaning tube.

Furthermore, a device with which the method described above can be embodied comprises: a cover plate provided with an outlet through which cleaning vapor flows out into an ordinary pressure working chamber thereabove; a condensation unit whereby cleaning vapor that flows out from the outlet in this cover plate and into the ordinary pressure working chamber thereabove condenses at a low position in the working chamber; and a tubular cleaning tube arranged in a space between this condensation unit and the outlet, so that the cleaning vapor rises up at the interior, such that cleaning vapor contacts an object to be cleaned that is received at the interior, allowing vapor cleaning.

### Effects of the Invention

Because, as described above, an outlet is provided in a cover plate, through which cleaning vapor flows out into an overhead ordinary pressure working chamber, and because the cleaning vapor flows out only from the outlet into the working chamber and the cleaning vapor does not flow to the entire interior of the working chamber, the present invention makes the management of cleaning vapor very easy. That is to say, when not vapor cleaning an object to be cleaned, the vapor that has flowed out from the outlet can be condensed by a condensation unit at a low position in the working chamber, so that there will be very little pushing up of air in the working chamber, which would result in discharge to the exterior of the working chamber.

Furthermore, when an object to be cleaned is vapor cleaned, a tubular cleaning tube is arranged on the top face of the cover plate, at the outer periphery of the outlet, so that the cleaning vapor can accumulate at the interior of this tubular cleaning tube. The volume of air that is pushed up by this cleaning vapor is approximately equal to the volume of this cleaning tube. Consequently, while conventionally all of the air in the working chamber was pushed out to the exterior, by causing the volume of this cleaning tube to be the minimum necessary for cleaning the object to be cleaned, only an amount of air corresponding to the volume of the cleaning tube will be pushed out to the exterior, which allows for a great reduction as compared to that which was conventional.

Furthermore, when an object to be cleaned in placed in the cleaning tube and vapor cleaned, the volume by which the cleaning vapor is reduced as a result of condensation by the object to be cleaned, will likewise correspond to the volume of the cleaning tube, and thus little air will flow into the cleaning chamber from the exterior. Furthermore, cleaning vapor that overflows from the cleaning tube can be condensed by the condensation unit at a low position in the working chamber, so that there will be very little influence on pushing of the air in the working chamber upwards.

### BRIEF DESCRIPTION OF THE DRAWINGS

FIG. 1 This is a sectional view illustrating Embodiment 1.

FIG. 2 This is a sectional view illustrating the manner in which an object to be cleaned is vapor cleaned in Embodiment 1.

FIG. 3 This is a sectional view illustrating Embodiment 2.

FIG. 4 This is a sectional view illustrating the manner in which an object to be cleaned is vapor cleaned in Embodiment 2.

FIG. 5 This is a sectional view illustrating Embodiment 3.

FIG. 6 This is a sectional view illustrating the manner in which an object to be cleaned is vapor cleaned in Embodiment 3.

### Working Example 1

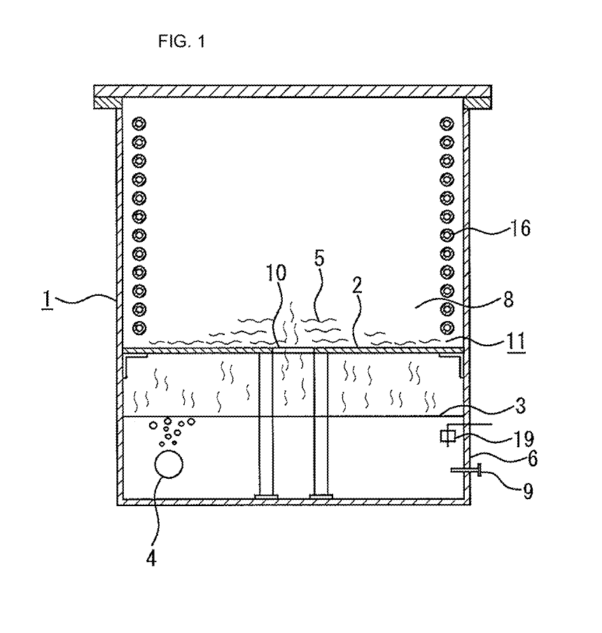

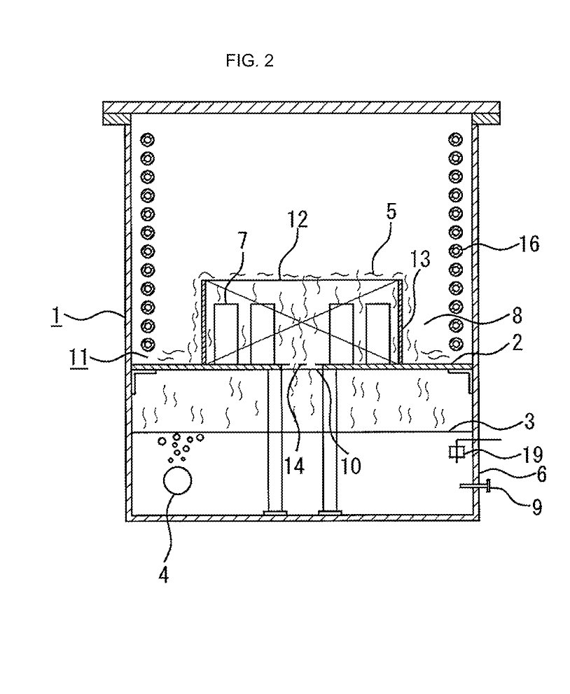

Hereafter, describing Embodiment 1 of the present invention by way of FIG. 1 and FIG. 2, (1) is a vapor cleaning tank, which is configured so as to be used under ordinary pressure conditions, the interior of which is vertically divided by a cover plate (2); the lower portion thereof is a vapor generation unit (6), wherein cleaning vapor (5) is generated by way of heating a cleaning solvent (3) with a heater (4); and the upper portion is a working chamber (8) where vapor cleaning of an object to be cleaned (7) is performed. In terms of the cleaning solvent (3), fluorine-based solvents such as HFC and HFE, bromine-based solvents, fluorine-based inert liquids such as PFC, PFPE, alcohols such as IPA, ethyl alcohol and methanol, hydrophilic solvents such as acetone, and chlorine-based solvents and the like can be used individually or a plurality thereof can be used. Furthermore, an outlet (10) is provided in the cover plate (2), through which the cleaning vapor (5) that has been generated in the vapor generation unit (6) flows into the ordinary pressure working chamber (8) thereabove.

Furthermore, a condensation unit (11) is configured by arranging a cooling pipe, through which cold water flows, in a spiral around the inner periphery of the working chamber (8) of the vapor cleaning tank (1) from the top of the working chamber (8) to the vicinity of the cover plate (2). By providing the condensation unit (11) on the inner face of the working chamber (8) in communication with the top face of the cover plate (2) in this manner, the cleaning vapor (5) that flows out from the outlet (10) is condensed in the vicinity of the cover plate (2) in the working chamber (8), and therefore does not rise upward within the working chamber (8), whereby it is possible to greatly reduce the pushing up of air within the working chamber (8) and the discharge thereof to the exterior.

Furthermore, a tubular cleaning tube (12) is arranged disposed in the space between the condensation unit (11) and the outlet (10). This cleaning tube (12) allows for vapor cleaning wherein the cleaning vapor (5) from the outlet (10) rises up at the interior, and the cleaning vapor (5) condenses on the object to be cleaned (7), which is received therein. An outer peripheral wall (13) of the cleaning tube (12) is formed without providing holes or the like, from a material that does not allow the passage of the cleaning vapor (5), such as a metal sheet or a resin sheet, and the top end thereof, which may be configured in an open manner, may be covered by a cover (not shown) that is formed from a material that allows the passage of the cleaning vapor (5), such as a mesh. Furthermore, a bottom plate (14) is also provided at the bottom of the cleaning tube (12), which is formed from a material such as a mesh that allows the passage of the cleaning vapor (5) but does not allow the object to be cleaned (7) to fall through. Furthermore, a temperature sensor (9) and a water level gauge (26) are provided in the vapor generation unit (6).

Furthermore, this cleaning tube (12) may be fixedly arranged on the top face of the cover plate (2), or maybe replaceably arranged on the top face of the cover plate (2). Furthermore, it is preferable that the cleaning tube (12) be given the minimum volume that accommodates the volume of the object to be cleaned (7), which is to undergo vapor cleaning. Additionally, if the cleaning tube (12) is to be used as a delivery box, handles of any sort (not shown) or the like may be connected to the cleaning tube (12). Furthermore, the condensation unit (11) described above is configured so that a portion thereof is arranged closer to the lower cover plate (2) than the top of the cleaning tube (12).

In order to perform vapor cleaning of an object to be cleaned (7) with a device configured in the manner described above, the cleaning solvent (3) in the vapor generation unit (6) is heated with a heater (4) so as to generate cleaning vapor (5). This cleaning vapor (5) flows into the working chamber (8) only through the outlet (10) provided in the cover plate (2). When not cleaning an object to be cleaned (7), this cleaning vapor (5) that has flowed out disappears as a result of condensation on the condensation unit (11) that is provided in communication with the top face of the cover plate (2) on the inner face of the working chamber (8), so that even during vapor cleaning work standby, there will be very little pushing up of the air in the working chamber (8) and outflow to the exterior.

Next, by way of arranging the tubular cleaning tube (12) at the outer periphery of the outlet (10), in the space between this and the condensation unit (11), the cleaning vapor (5) is prevented from flowing toward the condensation unit (11), so that the cleaning vapor (5) flows upward in the cleaning tube (12) and the cleaning vapor (5) condenses on the object to be cleaned (7), which is accommodated at the interior thereof, allowing for vapor cleaning of the same. While introduction of the cleaning vapor (5) into this tubular cleaning tube (12) does result in pushing out air in an amount corresponding to the volume of the cleaning tube (12) to the exterior, pushing of this air out to the exterior is limited to an amount corresponding to the volume of the cleaning tube (12), and therefore it is possible to greatly reduce the amount discharged as compared to the conventional case in which all of the air in the working chamber (8) was discharged to the exterior. Furthermore, because it is possible to give the cleaning tube (12) the minimum volume necessary to accommodate the object to be cleaned (7), it is possible to minimize discharge of air and wasted vapor.

Furthermore, because the cleaning vapor (5) condenses on the object to be cleaned (7) in the cleaning tube (12) and is thereby reduced during vapor cleaning, while outside air is introduced into the cleaning tube (12), this is limited to no more than the volume of the cleaning tube (12), and therefore it is possible to greatly reduce the amount of outside air introduced as compared to the conventional case in which vapor with the large volume of the interior of the working chamber (8) was condensed. Furthermore, because it is possible to give the cleaning tube (12) the minimum volume necessary to accommodate the object to be cleaned (7), it is possible to minimize the amount of outside air introduced. Furthermore, with regard to cleaning vapor (5) that overflows from the cleaning tube (12) during vapor cleaning work, the cleaning vapor (5) that flows out from the outlet (10) is condensed in the vicinity of the cover plate (2) by the condensation unit (11) that is provided on the inner face of the working chamber (8) in communication with the top face of the cover plate (2), and thus does not rise upward in the working chamber (8), allowing the pushing up of air within the working chamber (8) and discharge to the exterior to be greatly reduced.

Furthermore, the cleaning tube (12) may be fixedly arranged on the top face of the cover plate (2), and any dimensions may be selected for use, in accordance with the intended cleaning of the object to be cleaned (7). Furthermore, if handles (not shown) or the like are arranged on the cleaning tube (12) and this is used as a delivery box for the object to be cleaned (7), ordinary delivery boxes become unnecessary, whereby cleaning costs can be reduced.

### Working Example 2

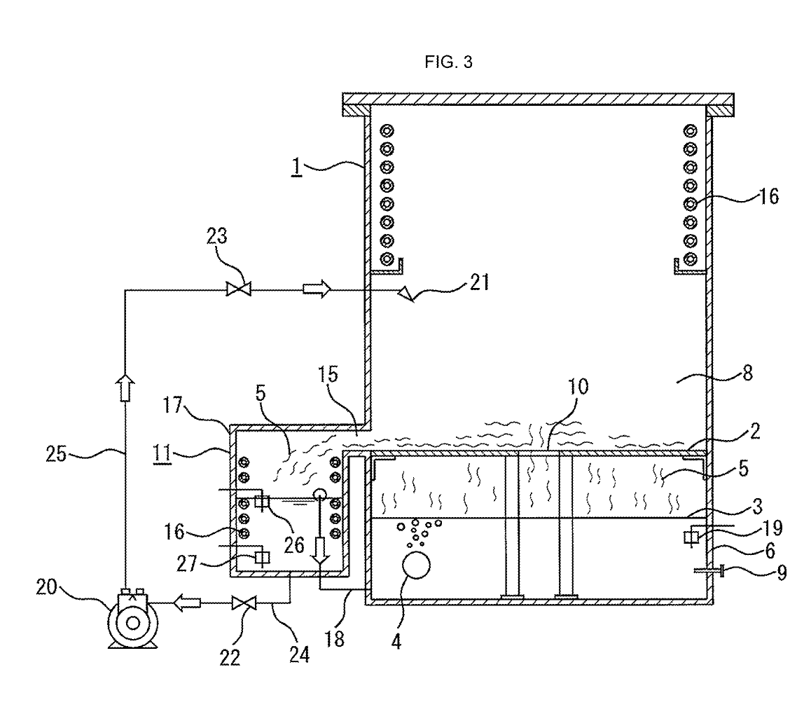

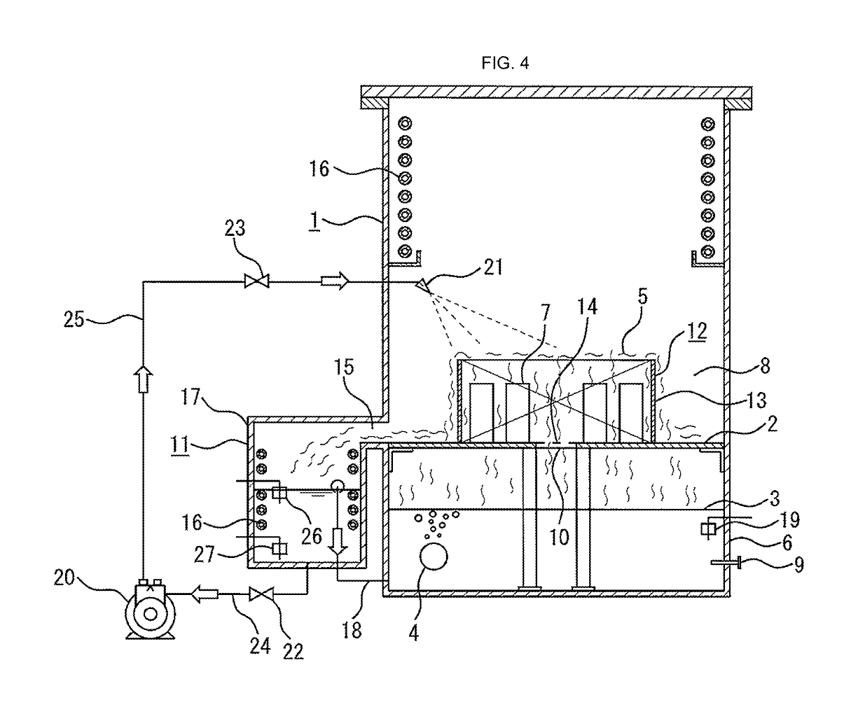

In embodiment 1 described above, the configuration is such that the condensation unit (11) is provided on the inner face of the working chamber (8) in communication with the top face of the cover plate (2), and a portion thereof is arranged closer to the lower cover plate (2) than the top of the cleaning tube (12). However, in Embodiment 2, as shown in FIG. 3 and FIG. 4, the configuration is such that the condensation unit (11) communicates with the working chamber (8) via a communication opening (15) provided at the top face of the cover plate (2) and at a horizontally lateral part thereof. The condensation unit (11) in this Embodiment 2 is configured such that cooled cleaning solvent (3) fills the interior of a cooling tank (17), at the inner periphery of which a cooling pipe (16) is arranged, through which cooling liquid passes. Here, when a vapor cleaning is not performed, the cleaning vapor (5) that flows out from the outlet (10) is introduced via the communication opening (15) and is condensed, which prevents air from being pushed up in the working chamber (8).

Additionally, overflow liquid produced as a result of the cleaning vapor (5) being condensed by this condensation unit (11) is returned to the vapor generation unit (6) via an overflow pipe (18). Furthermore, the cleaning solvent (3) in the condensation unit (11) is sprayed by a shower pump (20) onto the object to be cleaned (7) via a nozzle (21), allowing the object to be cleaned (7) to be shower cleaned. Additionally, this shower pump (20) is connected to the cleaning solvent (3) in the cooling tank (17) via an intake pipe (24), with a first open/close valve (22) therebetween, and to the nozzle (21), via an output pipe (25), with a second open/close valve (23) therebetween. Furthermore, water level gauges (26), (27) are arranged at the top and bottom of the cooling tank (17) and a cooling pipe (16) is wound at the top of the working chamber (8).

In embodiment 2, which is configured as described above, in order to perform vapor cleaning of the object to be cleaned (7), the cleaning solvent (3) is heated by a heater (4) in a vapor generation unit (6), so as to generate the cleaning vapor (5). Next, by way of arranging the tubular cleaning tube (12) at the outer periphery of the outlet (10), in the space between the outlet (10) and the condensation unit (11), the cleaning vapor (5) is prevented from flowing toward the condensation unit (11), so that the cleaning vapor (5) rises up in the cleaning tube (12) and the cleaning vapor (5) condenses on the object to be cleaned (7), which is received at the interior thereof, allowing for vapor cleaning of the same. Before this vapor cleaning, or at the same time as this vapor cleaning, the shower pump (20) is operated and the cleaning solvent (3) that has been cooled is sprayed on to the object to be cleaned (7) via the nozzle (21), so as to perform shower cleaning of the object be cleaned (7). After completion of the shower cleaning, the object to be cleaned (7), which has been cooled as a result of this shower cleaning, allows the cleaning vapor (5) to be condensed well, so that the object to be cleaned (7) can be thoroughly cleaned. Furthermore, in terms of pushing out of air from the working chamber (8), introduction of the same and the like, the outflow of the cleaning solvent (3) can be minimized in the same manner as in Embodiment 1.

As described above, Embodiment 2 has an advantage over Embodiment 1 in that liquid that has been regenerated by condensing the cleaning vapor (5) by way of condensation with the condensation unit (11) can be stored and used as shower cleaning liquid. However, by limiting this to a vapor cleaning function in Embodiment 1, the manufacturing costs are reduced, which has the advantage of allowing for inexpensive vapor cleaning.

### Working Example 3

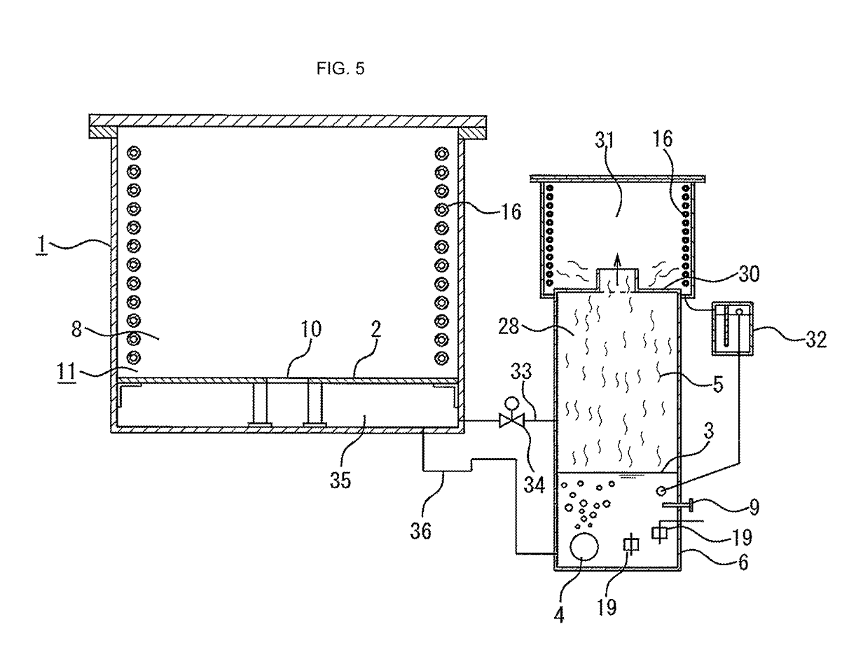

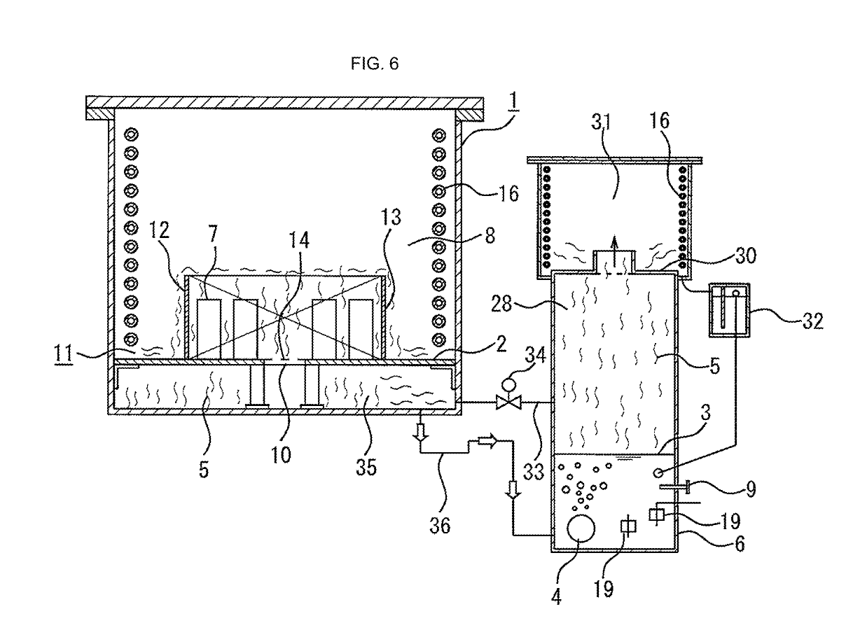

In Embodiments 1 and 2 described above, the vapor generation unit (6) was provided below the vapor cleaning tank (1), which is vertically divided by the cover plate (2), this vapor generation unit (6) was filled with cleaning solvent (3), and this cleaning solvent (3) was heated by the heater (4), so as to generate cleaning vapor (5). However, as shown in FIG. 5 and FIG. 6, in Embodiment 3, the vapor generation unit (6) is configured entirely separately from the vapor cleaning tank (1). The bottom of this vapor generation unit (6) is filled with cleaning solvent (3) and this cleaning solvent (3) is heated with a heater (4) so as to generate cleaning vapor (5). Additionally, an accumulation unit (28) for the cleaning vapor (5) is provided above the cleaning solvent (3), and a condensation chamber (31) is arranged above this accumulation unit (28), with a separator plate (30) therebetween. At the inner periphery of this condensation chamber (31), a cooling pipe (16), through which cooling water flows, is configured extending from the top of this condensation chamber (31) to the separator plate (30). Furthermore, this condensation chamber (31) and the accumulation unit (28) communicate via a communication opening (15) provided in the separator plate (30) such that cleaning vapor (5) that flows in to the condensation chamber (31) via the communication opening (15) can condense in the vicinity of the separator plate (30) without rising. Furthermore, this condensed condensate is refluxed to the portion for the cleaning solvent (3), via a water separator (32).

Furthermore, the accumulation unit (28) for the cleaning vapor (5) is connected to an input chamber (35) which is provided below a cover plate (2) in the vapor cleaning tank (1), via a vapor pipe (33) and a third open/close valve (34). Furthermore, this input chamber (35) communicates with a working chamber (8), via an outlet (10) provided in the cover plate (2), and a reflux pipe (36) through which the condensate is refluxed is connected to a part for filling with the cleaning solvent (3). The configuration is otherwise the same as in Embodiment 1 and Embodiment 2.

In embodiment 3, which is configured as described above, in order to perform vapor cleaning of the object to be cleaned (7), the cleaning solvent (3) is heated by a heater (4) in a vapor generation unit (6), so as to generate the cleaning vapor (5). Then, by opening the third open/close valve (34), as shown in FIG. 6, the cleaning vapor (5) is input to the input chamber (35) via the vapor pipe (33). Then, by surrounding the outer periphery of the outlet (10) with the cleaning tube (12) as shown in FIG. 6, the interior of the cleaning tube (12) is filled with the cleaning vapor (5), allowing the object to be cleaned (7) to be vapor cleaned. In this Embodiment 3, the vapor generation unit (6) is configured entirely separately from the vapor cleaning tank (1), and therefore it is possible to rapidly and reliably supply or stop the cleaning vapor (5) to the working chamber (8), by way of opening and closing the third open/close valve (34), which connects the vapor generation unit (6) and the vapor cleaning tank (1). Furthermore, when the vapor cleaning is not performed, the cleaning solvent (3) is recovered to, and sealed in, the vapor generation unit (6), allowing consumption of the cleaning solvent (3) when not in use to be reliably prevented.

### Explanation of the Reference Numerals

2 cover plate

3 cleaning solvent

5 cleaning vapor

6 vapor generation unit

7 object to be cleaned

8 working chamber

10 outlet

11 condensation unit

12 cleaning tube

15 communication opening

1. A method of vapor cleaning an object to be cleaned, characterized by: providing an outlet in a cover plate, through which cleaning vapor flows out into an ordinary pressure working chamber thereabove; allowing for condensation of this outflowing cleaning vapor by a condensation unit at a low position in the ordinary pressure working chamber; and arranging a tubular cleaning tube at the outer periphery of the outlet, on the top face of a cover plate, whereby the cleaning vapor rises up in the cleaning tube, so that an object to be cleaned can be vapor cleaned by receiving the object to be cleaned in this cleaning tube.

2. A device for vapor cleaning an object to be cleaned, characterized by comprising: a cover plate provided with an outlet through which cleaning vapor flows out into an ordinary pressure working chamber thereabove; a condensation unit whereby cleaning vapor that flows out from the outlet in this cover plate and into the ordinary pressure working chamber thereabove condenses at a low position in the working chamber; and a tubular cleaning tube arranged in a space between this condensation unit and the outlet, so that the cleaning vapor rises up at the interior, such that cleaning vapor contacts an object to be cleaned that is received at the interior, allowing vapor cleaning.

3. The method of vapor cleaning an object to be cleaned recited in claim 1, characterized in that the condensation unit is provided on the inner face of the working chamber, in communication with the top face of the cover plate.

4. The device for vapor cleaning an object to be cleaned recited in claim 2, characterized in that the condensation unit is provided on the inner face of the working chamber, in communication with the top face of the cover plate.

5. The method of vapor cleaning an object to be cleaned recited in claim 1, characterized in that the condensation unit communicates with the working chamber via a communication opening provided at the top face of the cover plate and at a horizontally lateral part thereof.

6. The device for vapor cleaning an object to be cleaned recited in claim 2, characterized in that the condensation unit communicates with the working chamber via a communication opening provided at the top face of the cover plate and at a horizontally lateral part thereof.

7. The method of vapor cleaning an object to be cleaned recited in claim 1, characterized in that the cleaning tube is fixedly arranged on the top face of the cover plate.

8. The device for vapor cleaning an object to be cleaned recited in claim 2, characterized in that the cleaning tube is fixedly arranged on the top face of the cover plate.

9. The method of vapor cleaning an object to be cleaned recited in claim 1, characterized in that the cleaning tube is replaceably arranged on the top face of the cover plate.

10. The device for vapor cleaning an object to be cleaned recited in claim 2, characterized in that the cleaning tube is replaceably arranged on the top face of the cover plate.

11. The method of vapor cleaning an object to be cleaned recited in claim 1, characterized in that a vapor generation unit, wherein cleaning vapor is generated by way of heating a cleaning solvent, is provided below the cover plate, and the outlet allows for the outflow of generated cleaning vapor from this vapor generation unit into the working chamber.

12. The device for vapor cleaning an object to be cleaned recited in claim 2, characterized in that a vapor generation unit, wherein cleaning vapor is generated by way of heating a cleaning solvent, is provided below the cover plate, and the outlet allows for the outflow of generated cleaning vapor from this vapor generation unit into the working chamber.

13. The method of vapor cleaning an object to be cleaned recited in claim 1, characterized in that the outlet receives a supply of cleaning vapor from a vapor generation unit that is provided separately from the cover plate and the working chamber, and allows for the outflow of the cleaning vapor into the working chamber.

14. The device for vapor cleaning an object to be cleaned recited in claim 2, characterized in that the outlet receives a supply of cleaning vapor from a vapor generation unit that is provided separately from the cover plate and the working chamber, and allows for the outflow of the cleaning vapor into the working chamber.
